(19) United States
(12) Patent Application Publication
(10) Pub. No.: US 2008/0267371 A1
(43) Pub. Date: Oct. 30, 2008

(54) TELEPHONE SYSTEM AND COMMUNICATION TERMINAL

(75) Inventor: Tsutomu Shibata, Hino-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/099,517

(22) Filed: Apr. 8, 2008

(30) Foreign Application Priority Data
Apr. 27, 2007 (JP) 2007-119843

(51) Int. Cl. H04M 11/00

(52) U.S. Cl. 379/93.17

(57) ABSTRACT

According to one embodiment, telephone system includes terminals can make telephone communication, call processor sets links connecting terminals at outgoing callers and terminals at incoming callers in response to outgoing call requests, and status manager manages statuses of terminals, wherein the terminal comprises display displays information, display controller displays a list of partner's destinations of communication of user registered in advance onto display, call processor reports outgoing call request for setting link between a terminal selected by user from list and a terminal of user to call processor, acquisition processor acquires status information showing statuses of terminals regarding partner's destinations on list, and management processor manages security levels of links set between terminal of user and terminals of partner's destinations on list on the basis of status information, and display controller displays security levels on display by associating with each of security levels of partner's destinations on list.

### CROSS-REFERENCE TO RELATED APPLICATIONS

This application is based upon and claims the benefit of priority from Japanese Patent Application No. 2007-119843, filed Apr. 27, 2007, the entire contents of which are incorporated herein by reference.

### BACKGROUND

1. Field

One embodiment of the present invention relates to a telephone system in which a telephone terminal and a softphone, etc., realize voice speech, for example, via an Internet Protocol (IP) network and a communication terminal for use in a telephone system of this kind.

2. Description of the Related Art

In recent years, Voice over IP (VoIP) telephone system which performs voice speech using the IP network has become widely used. Such a system of this kind transmits voice packets via an open network of the Internet, etc. Therefore, a higher technique than prior art for achieving securing communication by enhancing confidentiality of information has been required.

To assure security of communication, there is a method of implementing an encryption function to a telephone terminal and of authenticating the telephone terminal to put only authorized terminals on a network. However, in the present circumstances, the system having and not having such a function are intermixed. Especially, since a function of authenticating the terminals is positioned as a function owned by the network, a network which cannot process a protocol such as a session initiation protocol (SIP) may not be utilized. Therefore, a system, which may make a user know the situation of a partner's destination (a terminal at an incoming call destination) relating to the security before the start of the communication and may take appropriate measures, has been desired.

A related technique is disclosed in Jpn. Pat. Appln. KOKAI Publication No. 2005-159549. This patent document discloses a technique configured to confirm in advance whether or not the terminal at the partner's destination corresponds to IP service with high quality at an outgoing call origin. However, this technique also may not confirm the partner's destination situation relating to the security.

As mentioned above, it is hard for the existing telephone system to make the user determine in advance a security level capable of being provided (to be supported) from the terminal of the partner's destination. Accordingly, the existing telephone system may not relieve the user's sense of uneasiness regarding the confidentiality of the communication, and some measures are required.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a system view depicting an example of an embodiment of a telephone system regarding the invention;

FIG. 2 is a functional block diagram depicting an embodiment of a softphone terminal 4b of FIG. 1;

FIG. 3 is a view depicting an embodiment of a security level table 44b of FIG. 2;

FIG. 4 is a functional block diagram depicting an embodiment of a presence server 2 of FIG. 1;

FIG. 5 is a functional block diagram depicting an example of an embodiment of an exchange server 1 of FIG. 1;

FIG. 6 is a flowchart depicting an example of a processing procedure regarding registration of a communication terminal;

FIG. 7 is a flowchart depicting an example of a processing procedure regarding a subscription of status information in the softphone terminal 4b; and

FIG. 8 is a view depicting an example of display of a display unit 42 in a state in which the softphone terminal 4b starts a Click-to-Dial function.

### DETAILED DESCRIPTION

Various embodiments according to the invention will be described hereinafter with reference to the accompanying drawings. In general, according to one embodiment of the invention, there is provided a telephone system comprising: a plurality of communication terminals configured to make telephone communication; a call processing unit which sets a communication link connecting communication terminals at outgoing call origins and communication terminals at incoming call origins in response to outgoing call requests; and a status management unit which manages statuses of the plurality of communication terminals, wherein the communication terminal comprises: a display unit which displays information to a user; a display control unit which displays a list of partner's destinations of communication of the user who is registered in advance onto the display unit; a call processing section which reports an outgoing call request for setting the communication link between a communication terminal of a partner's destination selected by the user from the list and a communication terminal of the user to the call processing unit; an acquisition processing unit which acquires status information showing statuses of communication terminals regarding partner's destinations on the list from the status management unit; and a management processing unit which manages security levels of communication links which are set between the communication terminal of the user and the communication terminals of the partner's destinations on the list on the basis of the status information acquired from the status management unit, and the display control unit displays the security levels on the display unit by associating with each of the security levels of the partner's destinations on the list.

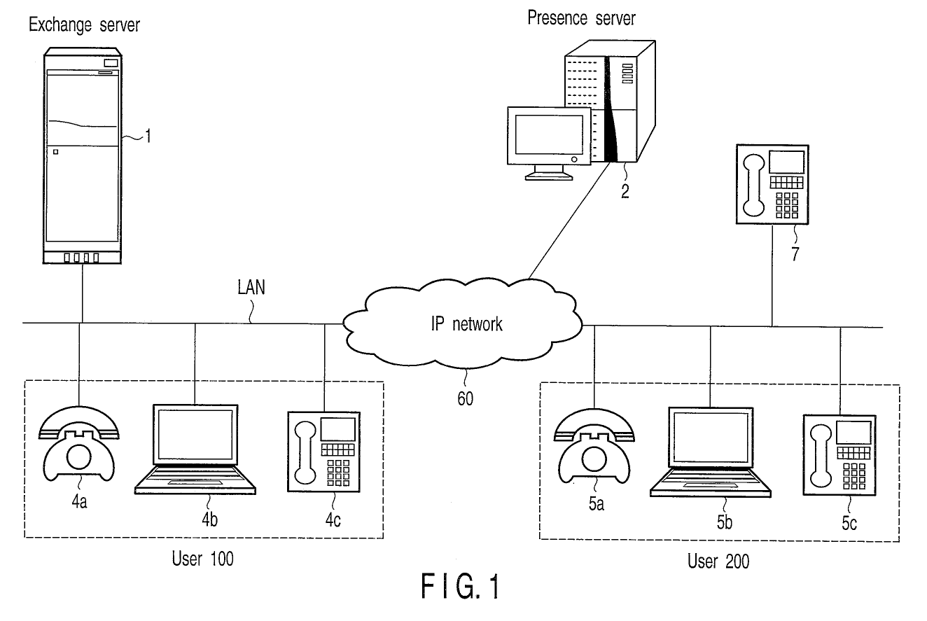

According to an embodiment, FIG. 1 shows a system view illustrating a form of an embodiment of a telephone system regarding the present invention. This system is a system which realizes voice speech by transmitting and receiving IP packets via an IP network 60, and is a so-called VoIP system. A plurality of local area networks (LANs) are connected to the IP network 60, and a user 100 and a user 200 belong to each LAN, respectively. Each LAN is a private communication network to be formed within an office to which each user 100, 200 belongs.

The LAN to which the user 100 belongs is provided with an exchange server 1. The exchange server 1 is a private branch exchange (PBX) which controls extension speech in the LAN and controls mutual speech between the LAN and an external network by transmitting an outgoing call signal to the external network.

When a call originating request occurs, the exchange server 1 sets a communication link to mutually connect communication terminals on the basis of an outgoing call origin address and an incoming call destination address included in this request. Although a similar device is disposed in the LAN to which the user 200 belongs, for the purpose of simplicity, the device is not shown in FIG. 1. A telephone terminal 7 which does not belong to any user may be disposed in the LAN.

The user 100 is under an environment in which a plurality of communication terminals may be used. In other words, the user 100 may use a plurality of communication terminals, such as an ordinary which may each make telephone calls via the IP network 60, such as an ordinary telephone set 4a, a software terminal 4b and an IP telephone set 4c which may each make telephone calls via the IP network 60. Similarly, the user 200 may use an ordinary telephone set 5a, a softphone terminal 5b, or an IP telephone terminal set 5c. The softphone is a name of a function which is realized by installing application software for voice speech into a personal computer.

Here, each terminal is associated with for each user. For instance, the softphone terminal 4b functions by cooperating with the IP telephone set 4c. Like this, the function to cooperate the terminals with one another has been known; the function may be actualized, for example, by setting to use a protocol such as an SIP. The function enables to realize Click-to-Dial such that the IP telephone set 4c makes a call to a desired partner's destination by clicking the telephone number displayed on a display device on the softphone terminal 4b. In this embodiment, it is assumed that a Click-to-Dial function is installed in the softphone terminal 4b of the user 100.

The IP network 60 is provided with the presence server 2. The presence server 2 manages an individual status of each communication terminal in the telephone system in real time. The presence server 2 manages the statuses of the ordinary telephone sets 4a, 5b, the softphone terminals 4b, 5b and the IP telephone sets 4c, 5c. The statuses of the terminals include the presence or absence of log-in by the user, and the statuses of the logged in user (present, absent, in meeting, etc.). The embodiment adopts attributes such as identifiers of terminals, identifiers of users, presence or absence of authentication, and supporting or non-supporting of encryption function, as the statuses of the terminals. The information showing the statuses is referred to as status information.

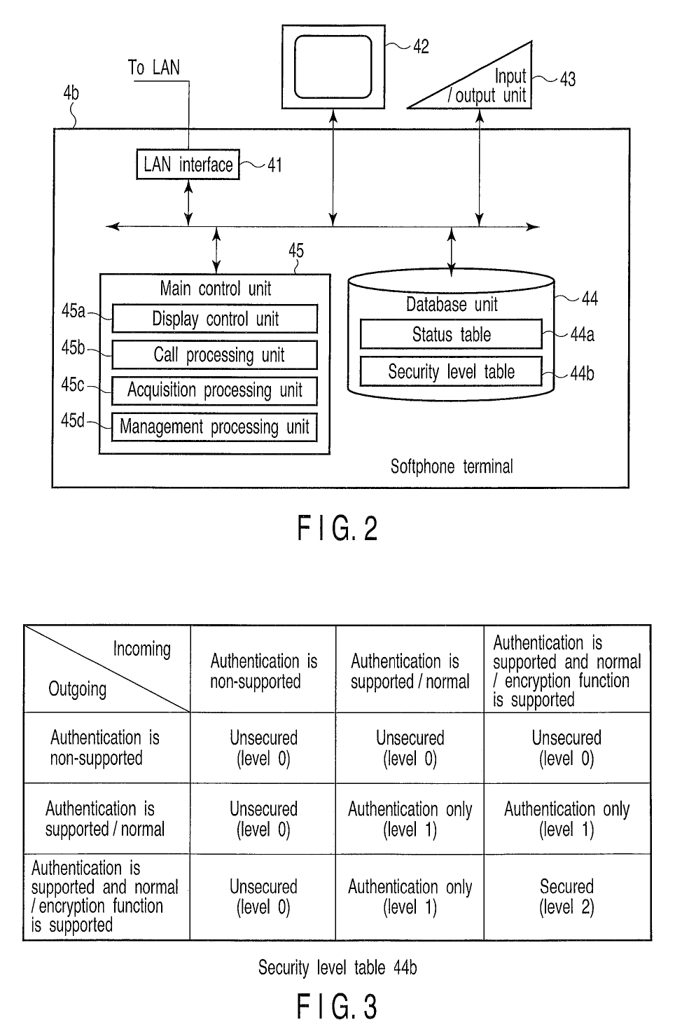

FIG. 2 is a block diagram illustrating an embodiment of the softphone 4b of FIG. 1. The softphone terminal 4b includes a LAN interface unit 41, a display unit 42, an input/output unit 43, a database unit 44, and a main control unit 45. The LAN interface unit 41 is connected to the LAN and serves for transmission and reception of packets. The display unit 42 displays a various kinds of information and serves some part of a user interface. The input/output unit 43 includes a keyboard and a mouse, and configures a graphical user interface (GUI) circumstance together with the display unit 42.

The database unit 44 is a storage device such as a hard disk drive, and stores a status table 44a and a security level table 44b to be depicted in FIG. 3. The status table 44a is a table which stores, in a database, statuses of communication terminals of the user's call originating destinations which have acquired from the presence server 2. This table is kept in the latest status while being updated.

FIG. 3 shows an embodiment of the security level table 44b of FIG. 2. This table is one for use in determining a rank of a security level. Whether authentication is present or not, whether a packet encryption function is supported or not, etc., become references of the rank. For instance, if both the outgoing call side terminal (outgoing) and the incoming call side terminal (incoming) are not authenticated, the security level is determined as the lowest rank, namely as unsecured rank (level 0). On the contrary, if both the terminals are normally authenticated and the encryption functions are also supported, the security level is determined as the highest rank, namely as the secured rank (level 2). The intermediate rank (level 1) is determined in the case in which only the authentication is performed normally, but the encryption function is not supported.

The main control unit 45 in FIG. 2 includes a display control unit 45a, a call processing unit 45b, an acquisition processing unit 45c and a management processing unit 45d.

When the telephone directory function is started, the display control unit 45a acquires telephone directory information of the user 100 to display the information on the display unit 42. Telephone numbers and names of candidates to be speech partner's destinations of the user 100 are registered in advance in the telephone directory by means of the known art, and a list of the partner's destinations is list-displayed on the display unit 42 by calling the telephone directory.

The call processing unit 45b reports an outgoing call request for setting a communication link between the communication terminal of the partner's destination selected by the user 100 from the telephone directory list and the communication terminal (e.g., IP telephone set 4c) of the user 100 via the IP network 60 to the exchange server 1 (shown in FIG. 1). For instance, by the SIP, an ‘INVITE’ message including an ‘SIP URI’ of the user 100 and an ‘SIP URI’ of the partner's destination is reported to the exchange server 1 from the call processing unit 45b.

The acquisition processing unit 45c acquires status information showing a status of a communication terminal regarding the partner's destination on the telephone directory list from the presence server 2. More specifically, the acquisition processing unit 45c requires a subscription of status information of the communication terminal corresponding to each partner's destination on the list to the presence server 2. After sending a message requesting the subscription once, the presence server 2 reports the fact of a change in status of each communication terminal to the softphone terminal 4b that is a request source each time or periodically.

The management processing unit 45d updates the status table 44a on the basis of the status change report from the presence server 2. Specifically, the management processing unit 45d writes the reported status (presence or absence of authentication, supporting or non-supporting of encryption function, etc.) of the partner's destination terminal into the status table 44a. Based on the written content, the management processing unit 45d manages the security level of the communication link among the user terminal 100 (ordinary telephone set 4a, softphone terminal 4b, IP telephone set 4c) and each partner's destination terminal. To set the security level, the security level table 44b in FIG. 3 is also used. The security level may be defined for each communication terminal, and may be defined for each communication link to be set among communication terminals.

Especially, in this embodiment, the display control unit 45a also displays the security levels managed by the management processing unit 45d by associating with the communication terminals of the partner's destinations (or partner's destinations themselves) on the telephone directory list.

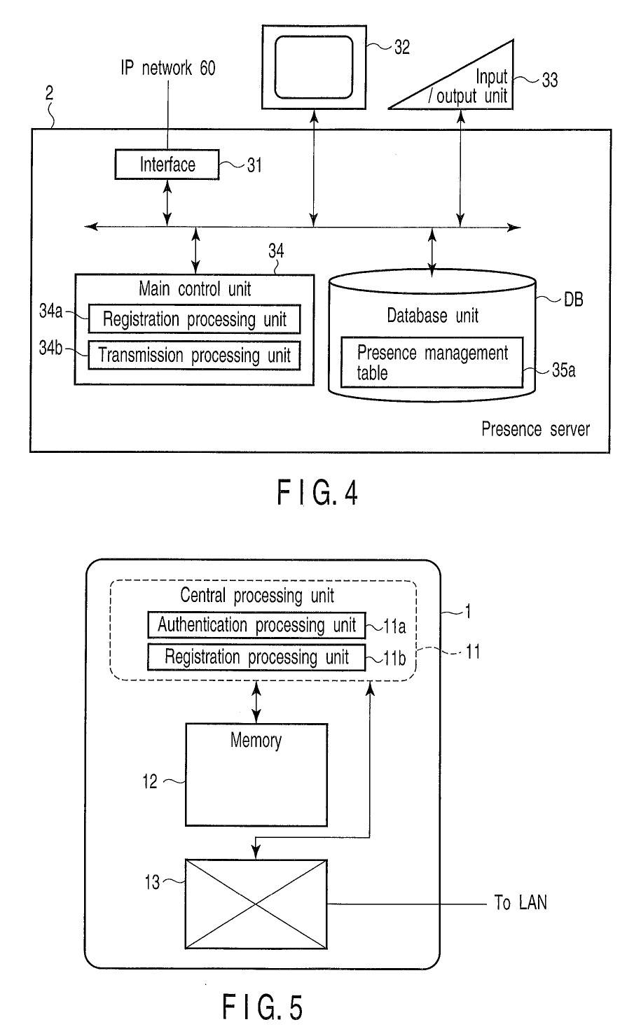

FIG. 4 is a functional block diagram illustrating an embodiment of the presence server 2 of FIG. 1. The presence server 2 includes an interface unit 31, a display unit 32, an input/output unit 33, a database unit DB, and a main control unit 34. The interface unit 31 is connected with the IP network 60 and serves to transmit and receive packets. The display unit 32 provides a user interface together with the input/output unit 33 to construct a GUI environment.

The database unit DB includes the presence management table 35a. The presence management table 35a is a table for managing the presence of all the communication terminals on the network. Each communication terminal reports the fact of the change in presence of the communication terminal to the presence server 2 by means of a ‘REGISTER’ message, etc. The presence server 2 reads the reported message to manage the presence management table 35a while updating the table 35a. The status table 44a of FIG. 2 differs from the presence table 35a in that the former targets only the presence of the partner's terminal device regarding the user 100 but the latter targets all the terminals in the system.

The main control unit 34 includes a registration processing unit 34a and a transmission processing unit 34b as processing functions regarding the embodiment.

The registration processing unit 34a registers the presence information reported from each communication terminal into the presence management table 35a. The transmission processing unit 34b delivers the presence information toward the communication terminals which have requested for subscriptions of the presence information. For this delivery, the transmission processing unit 34b may report the changed presence and may report only the difference from the preceding data. In short, it is enough that the fact of update of the presence is reported to the request source terminal.

FIG. 5 shows a functional block diagram illustrating an embodiment of the exchange server 1 of FIG. 1. The exchange server 1 receives an outgoing call, calling, response, disconnection messages from the communication terminals 4a, 4b, 4c, 5a, 5b, and 5c, determines the connecting destinations, and performs relay processing of the massages of which the connecting destinations have already determined. If the statuses of the communication terminals have changed, the exchange server 1 further reports the fact to the presence server 2.

The exchange server 1 is provided with a central processing unit 11, a memory 12 storing various programs and data necessary for processing of the central processing unit 11, and a switch unit 13. The central processing unit 11 includes an authentication processing unit 11a and a registration processing unit 11b as a processing function regarding the embodiment.

The authentication processing unit 11a authenticates the terminal of the request source in response to the authentication request message to be reported from each communication terminal. The ‘REGISTER’ message is used for the authentication request message, and the ‘REGISTER’ message includes attribute information such as an identification number, a user identifier, a user password, a user name, an extension number, and supporting or non-supporting of encryption function of the request source terminal. Regardless of the success or unsuccess of the authentication, the message indicating the authentication result is returned to the request source terminal. The registration processing unit 11b performs registration processing in response to the registration request message to be transmitted from the communication terminal requesting the registration thereof in the system.

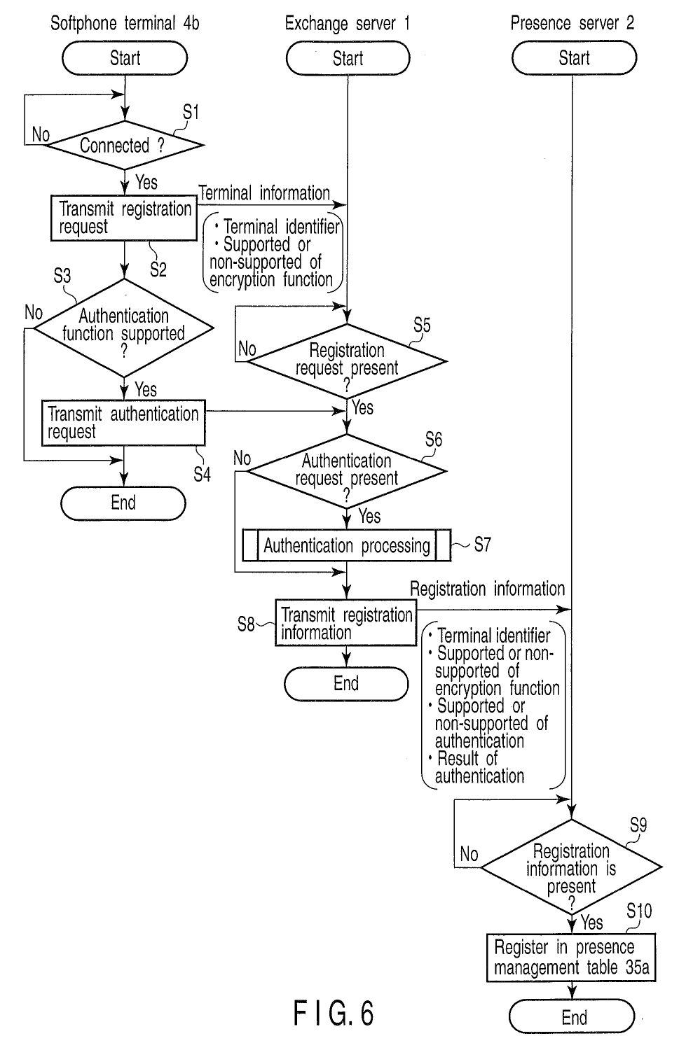

FIG. 6 is a flowchart illustrating a processing procedure regarding the registration of the communication terminal. Here, although the procedure related to the softphone terminal 4b will be described, the same applies to other communication terminals. In FIG. 6, if the connection to the LAN is detected (Yes, in Block S1), the softphone terminal 4b transmits a registration request for registering its own terminal (4b) into the system to the exchange server 1 (Block S2). The registration request includes the terminal information such as a terminal identifier and supporting or non-supporting of encryption function. If the softphone terminal 4b supports the authentication function (Yes, in Block S3), the softphone terminal 4b transmits the authentication request including the user identifier, the password, etc. of the logged in user (100) to the exchange server 1 (Block S4). Thereby, the fact that the softphone terminal 4b is used by the user 100 is reported to the system.

The exchange server 1 which has received the registration request (Yes, in Block S5), if the authentication request is made (Yes, in Block S6), performs the authentication processing (Block S7), then transmits the registration information including the terminal information to the presence server 2 (Block S8). The registration information includes information such as a terminal identifier, whether an encryption function is supported, whether an authentication is supported, and a result of authentication (in the case of the authentication is supported). The presence server 2 which has received the registration information (Yes, in Block S9) registers the registration information in the presence management table 35a as the presence information of the transmission source terminal.

The following will describe significant functions in this embodiment. In the following description, the following will be assumed for each communication terminal as regards the authentication and encryption function. That is, it is assumed that each ordinary telephone set 4c, 5c does not support an authentication function, each softphone terminal 4b, 5b supports an authentication function, and each IP telephone set 4c, 5c supports an authentication function and an encryption function.

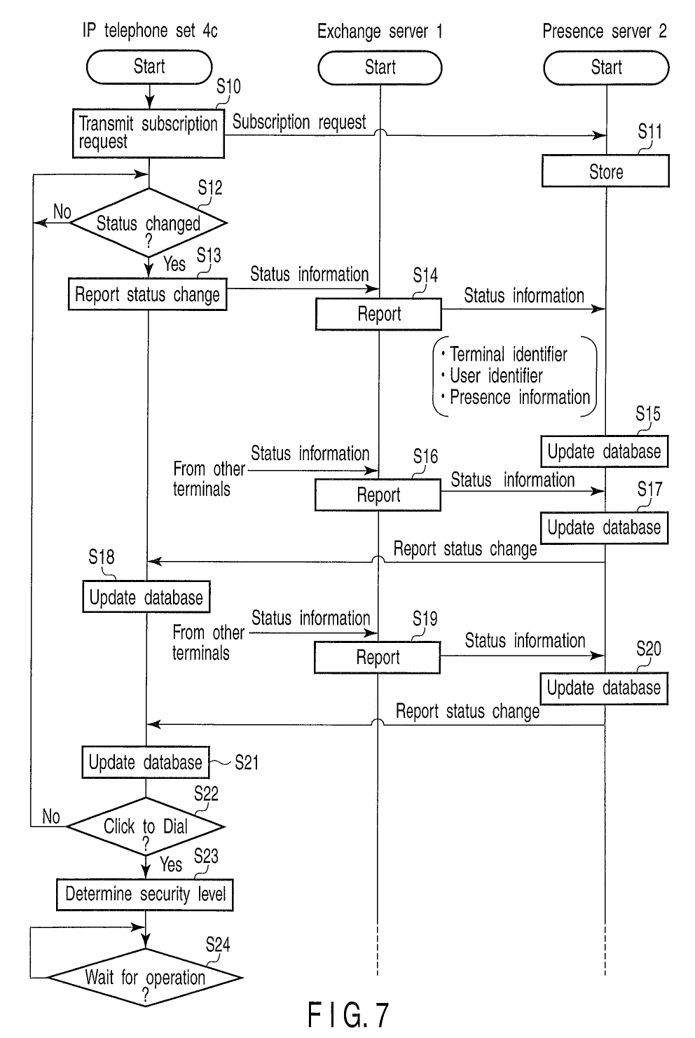

FIG. 7 is a flowchart illustrating a processing procedure regarding a subscription of status information at the softphone terminal 4b. For example, since the user 100 has every possibility of communication with the user 200, it is assumed that the user 100 wants to know the status of the user 200 in advance. The user 100 then inputs a command to know the statuses of the terminals 5a, 5b and 5c of the user 200 in the IP telephone set 4c. The IP telephone set 4c then transmits a subscription request for knowing the statuses of the terminals 5a, 5b and 5c to the presence server 2 (Block S10). The presence server 2 stores the fact of reception of the subscription request from the IP telephone set 4c (Block S1).

If the status of the IP telephone set 4c is changed (Yes, in Block S12), the fact is reported to the exchange server 1 (Block S13), the exchange server 1 reports the status change event to the presence server 2. The exchange server 1 reports the changed presence information as the status information to the presence server 2 together with the terminal identifiers and the user identifiers (Block S14). The status information also includes user names, status names, information on the securities (whether or not the authentication has normally completed, supporting or non-supporting of encryption function). The presence server 2 which has received the report updates the presence management table 35a (Block S15).

Each time the events of the status changes of other terminals are detected, the exchange server 1 reports the changed status information to the presence server 2. The presence server 2 which has received this status information updates the database DB (Blocks S16, S17). In FIG. 7, since the statuses of the terminals other than the IP telephone set 4c that is the subscription request source have changed, the presence server 2 reports that the statuses of other terminals have changed to the IP telephone set 4c. The IP telephone set 4c receives this fact and updates the data in the memory, or content of the status table 44a of the softphone terminal 4b to cooperate (Block S18). Similar processing is implemented each time there is a change in status of other terminals (Blocks S19, 20, 21).

In such a status, when the Click-to-Dial is started (Yes, in Block S22), the security level table 44b is referred from the content of the status table 44a, and the security levels of the partner's destinations to be displayed in list are determined (Block S23). The display unit 42 of the softphone terminal 4b displays the determination result together with the list and the telephone system waits for the operation by the user (Block S24).

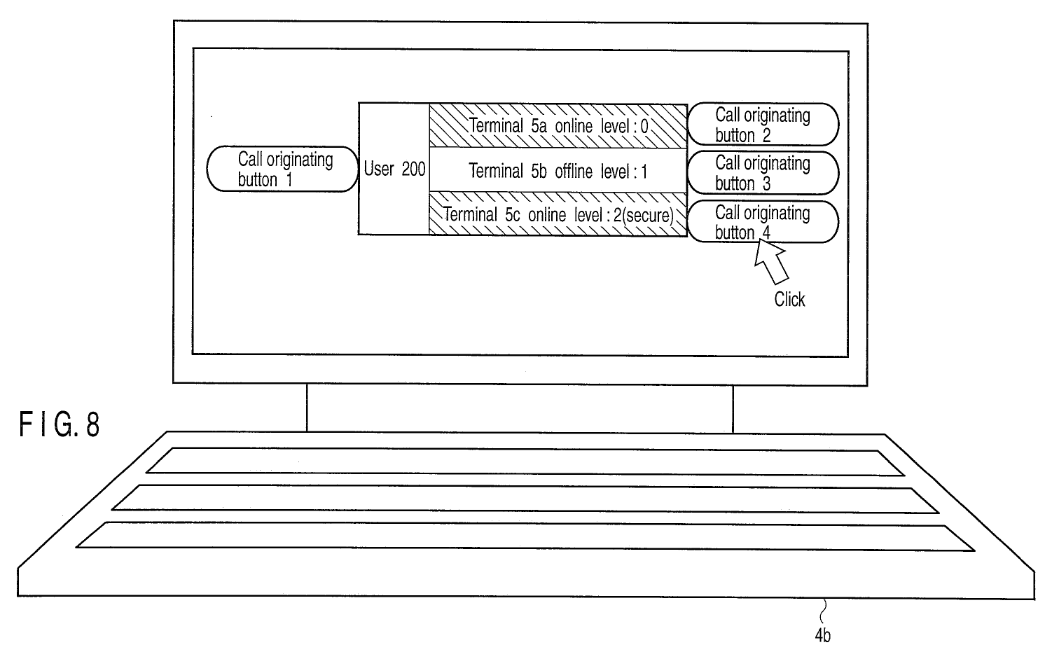

FIG. 8 shows a view illustrating an example of the display unit 42 in a status in which the softphone terminal 4b starts the Click-to-Dial function. The screen (window) shows a status of Block S24 (waiting for operation) of FIG. 7, the display unit 42 displays a list of the originating partner's destination candidates of the user 100. Although only the user 200 is illustrated as an example of the partner's destination, not only this one destination, a plurality of partner's destinations are displayed usually.

The window FIG. 8 shows that the user 200 has a plurality of terminals 5a, 5b and 5c. In addition to this, in this embodiment, the display unit 42 displays the information showing ‘online’ or ‘offline’ and the security level for each terminal of the user 200. Thereby, the user 100 may confirm the security level of the originating partner's destination at one view; therefore, the security of the communication becomes high.

FIG. 8 shows that the security level of the terminal (IP telephone) 5c is the highest level. The user 100 then may report the call request message between that user's IP telephone set 4c and the IP telephone set 5c of the user 200 by clicking a call originating button 4, and after this, the calling with the highest security level is set between both telephone sets 4c, 5c.

In this way, in the embodiment, in the telephone system having the Click-to-Dial function, the user terminal may transmit in advance the subscription request for receiving presence of other terminals to the presence server 2. Each time the presence of other terminals is updated, the fact is reported to the subscription request source terminal, and the user terminal locally manages the presence of the partner's destination terminals in the telephone directory database. When the Click-to-Dial is started, the security levels corresponding to the presence are confirmed in the terminals, the security levels are displayed together with the partner's destination list.

In other words, in the VoIP system in which the user terminal 100, the user terminal 200, and the presence server 2 are connected with one another via the IP network 60, the user on the outgoing call side transmits a request for recognizing the terminal status regarding the security of the partner's destination to the presence server 2. The presence server 2 then reports the security information of the partner side terminal to the outgoing call side user. Based on the information, the display unit 42 at the communication terminal of the outgoing call side user displays the security level of the communication terminal of the partner's destination user.

Thereby, in the VoIP communication, the user may easily determine the security level which can be provided from the communication terminal of the communication partner, and may conveniently utilize the secured communication with an easy operation. Thus, the user may recognize the security level which can be provided from the partner's destination terminal before making a call, and then, a telephone system and a communication terminal with enhanced communication confidentiality may be provided.

The invention is not limited to the specific details and representative embodiments shown and described herein. For instance, the softphone terminals 4b, 5b, the IP telephone terminals 4c, 5c may have communication functions other than audio, such as a video communication exchange function and a text chat function in addition to the aforementioned functions. While the embodiment has described the system in which the function of authenticating the communication terminals is owned by the exchange server 1, as a substitute for this, an exclusive server device serving the authentication processing may be disposed in the telephone system.

In FIG. 8, not by specifying the terminal of the partner's destination user, but by specifying the user, the system may be configured so that a call is automatically set to and from the terminal with the highest security level among a plurality of terminals. That is, when the originating button 1 for specifying the user 200 is clicked on the window in FIG. 8, the call processing unit 45b in FIG. 2 automatically selects the IP telephone set 5c, and transmits the call request message toward the IP telephone set 5c to the exchange server 1. In this way, the user may save a trouble such that the user must specify the partner's destination terminal, and the telephone system becomes further convenient.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone system comprising:
a plurality of communication terminals configured to make telephone communication;
a call processing unit which sets a communication link connecting communication terminals at outgoing call origins and communication terminals at incoming call origins in response to outgoing call requests; and
a status management unit which manages statuses of the plurality of communication terminals, wherein
the communication terminal comprises:
a display unit which displays information to a user;
a display control unit which displays a list of partner's destinations of communication of the user who is registered in advance onto the display unit;
a call processing unit which reports an outgoing call request for setting the communication link between a communication terminal of a partner's destination selected by the user from the list and a communication terminal of the user to the call processing unit;
an acquisition processing unit which acquires status information showing statuses of communication terminals regarding partner's destinations on the list from the status management unit; and
a management processing unit which manages security levels of communication links which are set between the communication terminal of the user and the communication terminals of the partner's destinations on the list on the basis of the status information acquired from the status management unit, and
the display control unit displays the security levels on the display unit by associating with each of the security levels of the partner's destinations on the list.

2. The telephone system according to claim 1, wherein
the acquisition processing unit requests for subscription of the status information to the status management unit;
the status management unit reports update information of the status information to a communication terminal of a request source of the subscription; and
the management processing unit manages the security levels on the basis of the update information.

3. The telephone system according to claim 1,
wherein
the acquisition processing unit acquires support information showing whether or not an encryption function of encrypting packets to be transmitted via the communication link is supported as the status information, and
the management processing unit manages the security levels on the basis of presence or absence of the encryption function at the communication terminal of user and the acquired support information.

4. The telephone system according to claim 1, further comprising:
an authentication unit which authenticates the plurality of communication terminals on the basis of each attribute, wherein
the acquisition processing unit acquires authentication information showing presence or absence of authentication by the authentication unit as the status information; and
the management processing unit manages the security levels on the basis of the presence or absence of the authentication of the communication terminal of the user by the authentication processing unit and the acquired authentication information.

5. The telephone system according to claim 1, wherein
the acquisition processing unit acquires connecting information showing whether the communication terminal is online or offline as the status information; and
the display control unit displays the acquired connecting information on the display unit by associating with each partner's destination on the list.

6. The telephone system according to claim 1, wherein:
when a plurality of incoming call destination communication terminals belong to the partner's destination,
the display control unit displays the security levels by associating with each incoming call destination communication terminal belonging to the partner's destinations on the list; and
the call processing unit reports an outgoing call request for setting the communication link between the incoming call destination communication terminal selected by the user from the list and the communication terminal of the user to the call processing unit.

7. The telephone system according to claim 1, wherein:
when a plurality of incoming call destination communication terminals belong to the partner's destination,
the call processing unit reports an outgoing call request for setting the communication link between an incoming call destination communication terminal configured to be set a communication link with the highest security level among incoming call destination communication terminals belonging to the selected partner's destination and the user's communication terminal to the call processing unit.

8. The telephone system according to claim 1, wherein:
when a plurality of user terminals belong to the user,
the management processing unit manages security levels of a communication link to be set between each of the user terminals and each of the communication terminals of partner's destinations on the list on the basis of the status information acquired from the status management unit; and
the call processing unit reports an outgoing call request for setting the communication link between a user terminal configured to be set a communication link with the highest security level among the plurality of user terminals and the selected communication terminal of the partner's destination to the call processing unit.

9. A communication terminal used in a telephone system which includes a call processing unit which sets a communication link for connecting a plurality of communication terminals configured to make telephone communication, a communication terminal of an outgoing call origin and a communication terminal of an incoming call destination; and a status management unit which manages statuses of the plurality of communication terminals, the communication terminal comprising:
a display unit which displays information to a user;
a display control unit which displays a list of partner's destinations of communication of the user registered in advance;
a call processing unit which reports an outgoing call request for setting the communication link between the communication terminal of a partner's destination selected by the user and the communication terminal of the user to the call processing unit;
an acquisition processing unit which acquires status information showing a status of communication terminals regarding the partner's destinations on the list from the status management unit; and
a management processing unit which manages security levels of communication links which are set between the communication terminals of the user and the communication terminals of the partner's destinations on the list on the basis of the status information acquired from the status management unit, wherein
the display control unit displays the security levels on the display unit by associating each of the security levels of the partner's destinations on the list.

10. The communication terminal according to claim 9, wherein
the acquisition processing unit acquires support information showing whether or not an encryption function of encrypting packets to be transmitted via the communication link is supported as the status information, and
the management processing unit manages the security levels on the basis of presence or absence of the encryption function at the communication terminal of the user and the acquired support information.

11. The communication terminal according to claim 9, wherein:
when the telephone system further includes an authentication unit which authenticates the plurality of communication terminals on the basis of each attribute,
the acquisition processing unit acquires authentication information showing presence or absence of authentication by the authentication unit as the status information, and
the management processing unit manages the security levels on the basis of the presence or absence by the authentication unit of the communication terminal of the user and the acquired authentication information.

12. The communication terminal according to claim 9, wherein
the acquisition processing unit acquires connecting information showing whether the communication terminal is online or offline as the status information, and
the display control unit displays the acquired connecting information on the display unit by associating with each of the partner's destinations on the list.

13. The communication terminal according to claim 9, wherein:
when a plurality of communication terminals belong to the partner's destination,
the display control unit displays the security levels by associating with each of incoming call destination communication terminals belonging to the partner's destinations on the list, and
the call processing unit reports an outgoing call request for setting the communication link between an incoming call destination communication terminal selected by the user and the communication terminal of the user to the call processing unit.

14. The communication terminal according to claim 9, wherein:
when a plurality of incoming call destination communication terminals belong to the partner's destination, wherein
the call processing unit reports an outgoing call request for setting the communication link between an incoming call destination communication terminal configured to be set a communication link with the highest security level among incoming call destination communication terminals belonging to the selected partner's destination and the communication terminal of the user to the call processing unit.

15. The communication terminal according to claim 9, wherein:
when a plurality of user terminals belong to the user,
the management processing unit manages security levels of a communication link which is set between each of the user terminals and each of the communication terminals of the partner's destination on the list on the basis of the status information acquired from the status management unit; and
the call processing unit reports an outgoing request for setting the communication link between a user terminal configured to be set a communication link with the highest security level among the plurality of user terminals and the communication terminal of the selected partner's destination to the call processing unit.
